(19) United States
(12) Patent Application Publication
(10) Pub. No.: US 2009/0282114 A1
(43) Pub. Date: Nov. 12, 2009

(54) System and method for generating suggested responses to an email

(76) Inventors: Junlan Feng, Basking Ridge, NJ (US); Mazin Gilbert, Warren, NJ (US)

Correspondence Address: AT & T Legal Department - WS;Attn: Patent Docketing, Room 2A-207, One AT & T Way, Bedminster, NJ, 07921, US

(21) Appl. No.: 12/151,632

(22) Filed: May 8, 2008

(51) Int. Cl. G06F 15/16

(52) U.S. Cl. 709/206

(57) ABSTRACT

Disclosed is a method and system for responding to a client email. A new client email is received and analyzed, and a response email is determined from the analyzing of the client email and from analysis of stored email-response pairs.

### BACKGROUND OF THE INVENTION

The present invention is generally directed to email, and more particularly to generating suggested responses to an email.

Each year, companies typically receive millions of emails from customers and consumers. Agents of a company are responsible for responding to these emails. Responding to the emails appropriately is often a time-consuming endeavor. In particular, agents have to respond to the email in a suitable fashion, such as attempting to resolve an email's query or complaint. Due to the large number of emails received, the aggregate time needed to respond to the emails is typically long and grows with each additional email.

One technique used by companies to speed up the time needed by an agent to respond to an email is by using response email templates. A response email template is an outline of a response to an email. An agent modifies a template to generate a specific response to an email.

There are typically hundreds of thousands of response email templates stored in a library. A computer can be used to suggest one or a few templates to an agent for a specific email. This may occur from a classification of a received email. Specifically, when a company receives an email from a customer, the email may be classified into a category based on the email's contents, subject line, previous email chain, user account status, etc. Each category is associated with one or multiple templates. For example, all emails pertaining to password reset may be responded to in a similar fashion using the same response email template.

It is typically difficult to define a good set of response templates with appropriate contents addressing the wide range of customers' requests and personal concerns. If the content of a suggested template is too broad, an agent has to fill in a lot of information. That increases the average email handling time. On the other hand, if a template is too specific, it might only be suitable for a few email requests. The template authors have to balance between these two ends. No matter how much effort is invested, it often happens that an agent finds that none of the templates are suitable for a matter asked in a customer email.

As a result, there remains a need for a more efficient technique to respond to emails.

### BRIEF SUMMARY OF THE INVENTION

In accordance with an embodiment of the present invention, a client email is received and analyzed, and one or more stored response emails are determined to be the most relevant by a computer from analyzing the client email and from analysis of stored email-response pairs. An agent can use the suggested response email directly or modify it to answer the client email.

Data cleanup and email pre-processing can be performed on the stored email-response pairs. Data cleanup can include filtering out a response email that has a low customer satisfaction, fails to address a user's concerns, or is grammatically or legally incorrect. Email pre-processing can include segmenting email-response pairs into sentences, parsing each sentence into syntactic trees, extracting Named Entities and assigning semantic labels to each sentence. Analysis of stored email-response pairs can additionally include determining generalized lexical/semantic associations between client email language and email-response language. In one embodiment, generalizing a response email occurs by replacing a value in the response email with a placeholder, such as a customer ID, confirmation number, date, amount, etc.

The analysis of the client email can also include similar steps. For example, the analysis of the client email can include segmenting the client email into sentences, assigning syntactic and semantic labels to each sentence, and extracting Named Entities from each sentence. The analysis may also include determining a lexical/semantic association between the client email and at least part of an email-response pair.

In one embodiment, the generating of a response email includes matching a client email with one or more stored client emails of the stored email-response pairs and/or matching a client email with one or more stored response emails of the stored email-response pairs. Further, metrics of the matching can be inferred from a model, which is learned from pairs of stored client emails and stored response emails using statistical and machine learning methods.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a system including a server having a response email generation module in accordance with an embodiment of the present invention;

FIG. 2 is a block diagram of an embodiment of the response email generation module of FIG. 1;

FIG. 3A is a flowchart illustrating the email pre-processing steps performed by the response email generation module in accordance with an embodiment of the present invention;

FIG. 3B is a flowchart illustrating the new client email processing steps in accordance with an embodiment of the present invention; and

FIG. 4 is a high level block diagram of a computer in accordance with an embodiment of the present invention.

### DETAILED DESCRIPTION

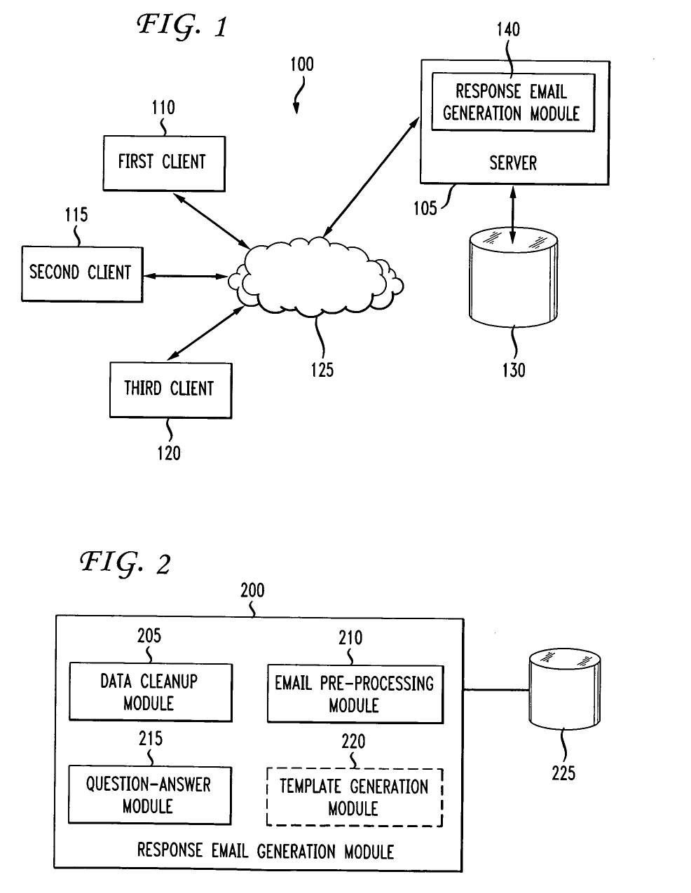

FIG. 1 shows a block diagram of a system 100 including a server 105 in communication with a first client 110, a second client 115, and a third client 120 over a network 125 such as the Internet.

The server 105 receives a plurality of emails from the clients 110, 115,120. The server 105 may be a server of a company. One or more agents of the company respond to the one or more emails received from the clients 110, 115, 120. In one embodiment, emails received from the clients 110, 115, and 120 (referred to herein as client emails) and corresponding email responses (referred to herein as response emails) are stored in a database 130. A client email and the corresponding response email (that was transmitted in response to the receipt of the client email) are referred to herein as an email-response pair.

The server 105 includes a response email generation module 140. The response email generation module 140 generates response emails from previously stored email-response pairs. For example, the server 105 receives a new client email from the first client 110. The response email generation module 140 analyzes the new client email and then searches the database 130 for one or more stored email-response pairs that correlate with the new client email. In one embodiment, the response email generation module 140 uses question-answer (QA) technology to generate a suggested response email, with the new client email (or one or more sentences of the new client email) treated as a new question (or questions), stored client emails (or parts of the stored client emails) treated as prior questions and their corresponding (stored) response emails (or parts of the stored response emails) treated as prior answers.

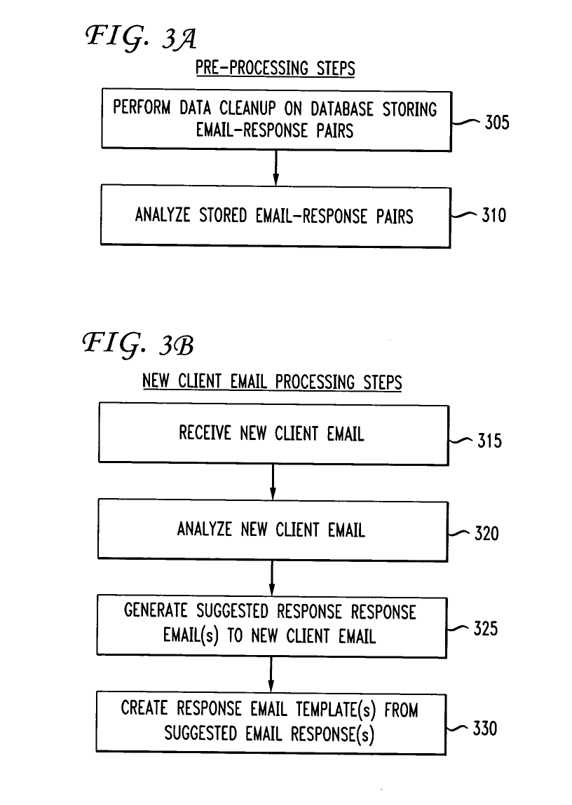

FIG. 2 shows a block diagram of an embodiment of a response email generation module 200. The response email generation module 200 includes a data cleanup module 205, an email pre-processing module 210, a question-answer (QA) module 215, and a template generation module 220. The response email generation module 200 is in communication with a database 225 which stores email-response pairs.

The data cleanup module 205 determines email-response pairs that satisfy one or more predetermined criteria from the email-response pairs stored in database 225. For example, if a particular agent has a reputation of effectively answering client emails and appropriately resolves issues raised in client emails, any email-response pairs associated with the particular agent may be selected for use by the response email generation module 200. As a result, the data cleanup module 205 transmits the email-response pairs associated with that particular agent to the next module (i.e., the email pre-processing module 210) of the response email generation module 200. As another example, suppose a different agent has a reputation of not effectively answering client emails and not resolving issues raised in the client emails. The data cleanup module 205 does not transmit email-response pairs associated with this other agent to the next module (i.e., the email pre-processing module 210).

In one embodiment, a customer satisfaction score is received from a customer after a customer receives a response email. This customer satisfaction score indicates how satisfied the customer was to the response email. In one embodiment, the customer satisfaction score is a number in a range (e.g., 5 out of 10).

In one embodiment, the data cleanup module 205 filters out response emails associated with a low customer satisfaction score. A customer satisfaction score may be considered low if it is below a predetermined threshold. For example, a customer may assign a customer satisfaction score below a predetermined threshold to a first response email. The data cleanup module 205 can then filter out email-response pairs from the database if the response email in an email-response pair is similar enough to the first response email.

In another embodiment, there are multiple email-response pairs associated with a single client email. For example, there may be a chain of stored client emails and stored responses associated with an initial client email. This chain (including the initial client email) may be analyzed by the data cleanup module 205 to determine that this chain should be excluded from further analysis. For example, if the number of stored email-response pairs is above a predetermined number (e.g., seven stored client emails and seven stored responses before the issue raised in the initial client email in the chain was resolved), the data cleanup module 205 may determine that this stored email-response pair is too lengthy (i.e., too many client emails and corresponding responses before the issue was resolved) and does not transmit the chain of email-response pairs to the email pre-processing module 210.

The email chain is considered in order to understand users' concerns. In one embodiment, the data cleanup module 205 filters out response emails that fail to address users' concerns. This determination may be based on language understanding performed by the data cleanup module 205.

In one embodiment, the data cleanup module 205 filters out response emails that are grammatically or legally incorrect. This may be based on grammar and/or legal rules stored by the data cleanup module 205.

The email pre-processing module 210 analyzes a stored client email as one or more questions and analyzes a stored corresponding response as one or more answers to the one or more questions. In particular, the email pre-processing module 210 segments a stored client email and a stored response into sentences, parses each sentence into syntactic trees, extracts Named Entities (i.e., a name such as a company name, an individual's name, a name of a web page, a location, etc.), and assigns semantic labels to each sentence or sequence of sentences. These semantic labels (and syntactic trees) are then used by the QA module 215.

The QA module 215 suggests one or more response emails for responding to a new client email. The QA module 215 suggests a response email based on the QA module's “learning” of database 225 (i.e., the QA module's analysis of previously received client emails and their corresponding response emails stored in database 225). The “learning” or analysis includes lexical/semantic association between equivalent stored client email requests and/or lexical/lexical semantic association between a stored client email and its stored response.

The QA module 215 analyzes a new client email in view of its past learning of database 225. In one embodiment, response emails are suggested based on matches between the new client email and the stored client emails that occur. Further, response emails can also be suggested based on any matches between the new client email and the stored response emails that occur. These matches may be identical matches or may be emails that are similar to a particular degree, such as emails which express similar concerns but are formulated in different ways. After analyzing the new client email, the QA module 215 outputs zero, one or more suggested response emails to respond to the new client email.

In one embodiment, a learning procedure infers metrics from the comparison between client emails and stored client emails in the email-response pairs and generates a model of how similar customer emails are with respect to stored client emails. Further, a learning procedure can also infer metrics from the comparison between client emails and stored response emails in the email-response pairs and generates a model of how relevant customer emails are with respect to stored response emails.

In one embodiment, the new client email being analyzed is part of an email chain consisting of several stored client emails and corresponding stored response emails. In this embodiment, the QA module 215 transmits its suggested response email(s) to a template generation module 220. The template generation module 220 can generate one or more templates associated with the suggested response emails, such as by replacing the Named Entities in the suggested response emails with a generic placeholder (e.g., replacing the name “William” with “Name”). Thus, in one embodiment, the response emails suggested by the response email generation module 200 are response email templates that can be modified by an agent before sending to a client in response to receiving a new client email.

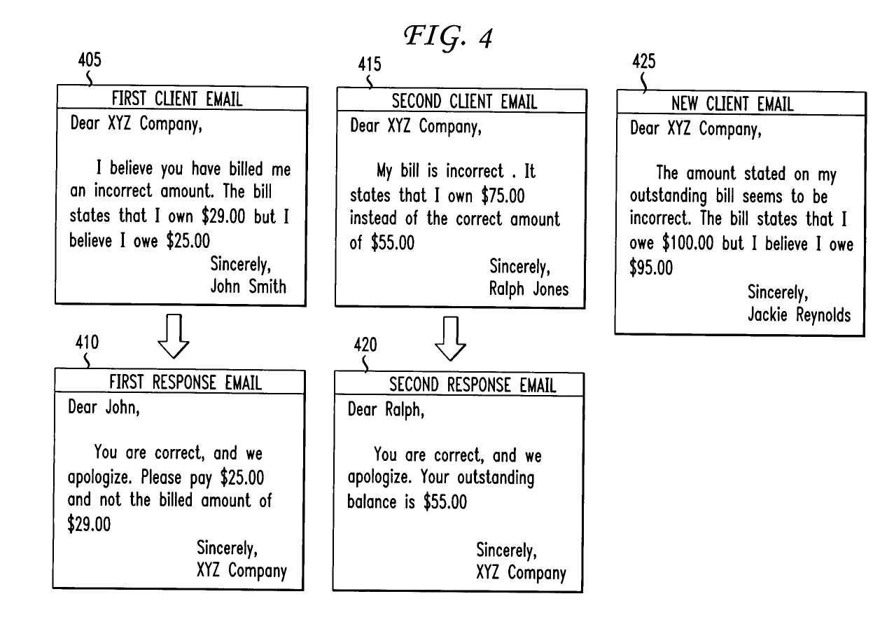

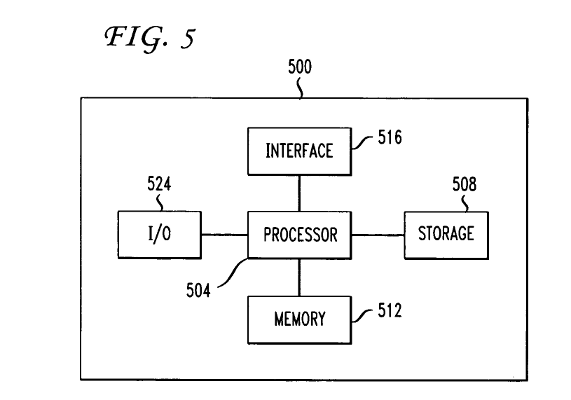

FIG. 3A shows a flowchart of the email pre-processing steps performed by the response email generation module 200. FIG. 3B is a flowchart illustrating the new client email processing steps. FIG. 4 shows an example of a stored first client email 405 and a stored corresponding first response email 410 and a stored second client email 415 and a stored corresponding second response email 420. The first client email 405 and first response email 410 are stored in database 225 as a first email-response pair 405, 410 and the second client email 415 and second response email 420 are stored in database 225 as a second email-response pair 415, 420.

As shown in FIG. 3A, before receiving a new client email, the response email generation module 200 performs email pre-processing steps. As part of these steps, the response email generation module 200 performs data cleanup on the database 225 storing the email-response pairs (e.g., email-response pairs 405, 410, 415, 420). As described above, the data cleanup may include filtering/removing some of the email-response pairs from further analysis, such as email-response pairs that have a low customer satisfaction score, fail to address users' concerns, and/or are legally or grammatically incorrect. The response email generation module 200 (e.g., the email pre-processing module 210) then analyzes the stored email-response pairs in step 310. As described above, this analysis includes segmenting the textual content of stored client emails and response emails into sentences, parsing each sentence into syntactic trees, extracting Named Entities, and assigning semantic labels to each sentence or sequence of sentences. For example, the response email generation module 200 extracting Named Entities may include substituting Name for “John” and “Ralph” in the first response email 410 and the second response email 420, respectively. Further, the response email generation module 200 may substitute Amount1 for “$29.00” and Amount2 for “$25.00” in the stored first client email 405 and the stored first response email 410. Similarly, the response email generation module 200 may substitute Amount3 for “$75.00” and Amount4 for “$55.00” in the stored second client email 415 and the stored second response email 420. Thus, specific values in client emails and/or response emails may be replaced with placeholders, such as customer ID, confirmation number, date, amount, etc.

As part of the analysis performed in step 310, the QA module 215 can “learn” about the stored email-response pairs stored in the database 225. The “learning” is determining one or more of lexical/semantic association between the first and second client emails 405, 415, and/or lexical/lexical semantic association between the stored first client email 405 and the stored first response email 410 and between the stored second client email 415 and the stored second response email 420. For example, the response email generation module 200 can determine that the first client email 405 and the second client email 415 have sentences that mean the same thing (e.g., except for the amounts stated). Similarly, the first response email 410 and the second response email 420 also have sentences that mean the same thing (e.g., except for the amounts stated).

Once the email pre-processing steps are performed on the email-response pairs stored in database 225, the response email generation module 200 waits to receive a new client email. Referring to FIG. 3B and FIG. 4, a new client email 425 is received in step 315. The new client email 425 is then analyzed by the QA module 215 in step 320. The analysis of the new client email may be similar to the analysis of the stored email-response pairs.

In one embodiment, the QA module 215 compares the contents of the new client email 425 with the contents of the stored first client email 405 and the stored second client email 415 to determine that the new client email 425 should be answered in a manner that is similar to the stored first response email 410 and the stored second response email 420. The response email generation module 200 uses this information to generate one or more suggested response emails to the new client email 425 in step 325. In one embodiment, the response email generation module 200 also determines how to format the suggested response email(s) based on the format of the stored first and second response emails 410, 420.

In one embodiment, the response email generation module 200 generates a response email template from each suggested response email in step 330. A template is an outline of a response email that the response email generation module 200 generates from the first and second response emails 410, 420. An agent typically has to modify the template before responding to the new client email 425, but the amount of modification is often minimal. Further, using a template or one of the suggested emails to respond to the new client email 425 is often more efficient than generating a new response email from scratch.

Further, a client email can be analyzed in view of a user's account information. In one embodiment, the response email generation module 200 retrieves customer account information from the database 225. The customer account information may then be automatically inserted into one or more locations of a suggested response email. For example, a suggested response email to the new client email 425 may include the amounts $95.00 and $100.00 (rather than a generic word Amount). This information can be automatically retrieved from the database 225.

In one embodiment, the response email generation module 200 applies language generation techniques to generate a suggested response email when none of the previously generated suggested response emails are considered suitable. Additionally, the response email generation module 200 may have the ability to determine the quality of its suggested response emails. Further, for some client emails, the response email generation module 200 may not return suggested response emails if the generated suggested response emails are not of a high enough quality.

FIG. 5 shows a high level block diagram of a computer 500 which may be used to implement the response email generation module. The computer 500 can, for example, perform the steps described above (e.g., with respect to FIGS. 3A and 3B). Computer 500 contains a processor 504 which controls the overall operation of the computer by executing computer program instructions which define such operation. The computer program instructions may be stored in a storage device 508 (e.g., magnetic disk, database) and loaded into memory 512 when execution of the computer program instructions is desired. Thus, the computer operation will be defined by computer program instructions stored in memory 512 and/or storage 508 and the computer will be controlled by processor 504 executing the computer program instructions. Computer 500 also includes one or more interfaces 516 for communicating with other devices. Computer 500 also includes input/output 524 which represents devices which allow for user interaction with the computer 500 (e.g., display, keyboard, mouse, speakers, buttons, etc.). One skilled in the art will recognize that an implementation of an actual computer will contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for generating one or more response emails for responding to a client email after performing analysis on stored email-response pairs comprising:
receiving said client email;
analyzing said client email; and
generating at least one response email by matching said client email and said stored email-response pairs.

2. The method of claim 1, further comprising performing data cleanup on said stored email-response pairs.

3. The method of claim 2, further comprising filtering out a response email that has a low customer satisfaction score, fails to address a user's concerns, or is grammatically or legally incorrect.

4. The method of claim 1 further comprising generalizing a response email by replacing a value in said response email with a placeholder.

5. The method of claim 1 further comprising syntactically and semantically parsing textual content of said client email and stored email-response pairs.

6. The method of claim 5 further comprising:
segmenting the textual content into sentences; and.
assigning syntactic and semantic labels to each of said sentences.

7. The method of claim 6 further comprising extracting Named Entities from each of said sentences.

8. The method of claim 1 wherein said determining a response email further comprises at least one of matching a client email with one or more stored client emails of said stored email-response pairs and matching a client email with one or more stored response emails of said stored email-response pairs.

9. The method of claim 8 further comprising:
inferring metrics of said matching; and
modeling a similarity measurement between client emails and stored emails.

10. The method of claim 1 wherein said analysis of said stored email-response pairs further comprises determining one or more of lexical and semantic associations between a client email and its corresponding response email.

11. A system for generating one or more response emails for responding to a client email after performing analysis on stored email-response pairs comprising:
means for receiving said client email;
means for analyzing said client email; and
means for generating at least one response email by matching said client email and said stored email-response pairs.

12. The system of claim 11 further comprising means for performing data cleanup on said stored email-response pairs.

13. The system of claim 11 further comprising means for filtering out a response email that has a low customer satisfaction score, fails to address a user's concerns, or is grammatically or legally incorrect.

14. The system of claim 11 further comprising means for generalizing a response email by replacing a value in said response email with a placeholder.

15. The system of claim 11 further comprising means for syntactically and semantically parsing textual content of said client email and stored email-response pairs.

16. The system of claim 15 further comprising:
means for segmenting the textual content into sentences; and
means for assigning syntactic and semantic labels to each of said sentences.

17. The system of claim 16 further comprising means for extracting Named Entities from each of said sentences.

18. The system of claim 11 wherein said means for determining a response email further comprises at least one of means for matching a client email with one or more stored emails of said stored email-response pairs and means for matching a client email with one or more stored responses of said stored email-response pairs.

19. The system of claim 18 further comprising:
means for inferring metrics of said matching of a client email with stored emails; and
means for modeling a similarity measurement between client emails and stored emails.

20. The system of claim 11 wherein said analysis of said stored email-response pairs further comprises means for determining one or more of lexical and semantic associations between a client email and its corresponding response email.

21. A computer readable medium comprising computer program instructions capable of being executed in a processor and defining the steps comprising:
receiving said client email;
analyzing said client email; and
generating at least one response email by matching said client email and said stored email-response pairs.

22. The computer readable medium of claim 21 further comprising performing data cleanup on said stored email-response pairs.

23. The computer readable medium of claim 22 further comprising filtering out a response email that has a low customer satisfaction score, fails to address a user's concerns, and is grammatically or legally incorrect.

24. The computer readable medium of claim 21 further comprising generalizing a response email by replacing a value in said response email with a placeholder.

25. The computer readable medium of claim 21 further comprising syntactically and semantically parsing textual content of said client email and stored email-response pairs.

26. The computer readable medium of claim 25 further comprising:
segmenting the textual content into sentences; and
assigning syntactic and semantic labels to each of said sentences.
